(19) United States
(12) Patent Application Publication
(10) Pub. No.: US 2025/0300420 A1
(43) Pub. Date: Sep. 25, 2025

(54) LASER BEAM DEVICE AND METHOD FOR PRODUCING COHERENCE

(71) Applicant: Rheinmetall Waffe Munition GmbH, Suedheide (DE)

(72) Inventors: Markus JUNG, Graben-Neudorf (DE); Benjamin NEUMANN, Luebeck (DE)

(73) Assignee: Rheinmetall Waffe Munition GmbH, Suedheide (DE)

(21) Appl. No.: 19/231,194

(22) Filed: Jun. 6, 2025

Related U.S. Application Data
(63) Continuation of application No. PCT/EP2023/081080, filed on Nov. 8, 2023.

(30) Foreign Application Priority Data
Dec. 7, 2022 (DE) 10 2022 132 521.0

(51) Int. Cl. H01S 3/10; G01J 1/42; H01S 3/00; H01S 3/107

(52) U.S. Cl. CPC H01S 3/10053; G01J 1/4257; H01S 3/0014; H01S 3/107

(57) ABSTRACT

A laser beam apparatus for irradiating a target object and a method for operating such a laser beam apparatus. According to an example, at least two laser beams are made coherent.

This nonprovisional application is a continuation of International Application No. PCT/EP2023/081080, which was filed on Nov. 8, 2023, and which claims priority to German Patent Application No. 10 2022 132 521.0, which was filed in Germany on Dec. 7, 2022, and which are both herein incorporated by reference.

### BACKGROUND OF THE INVENTION

### Field of Invention

The invention relates to a laser beam apparatus for irradiating a target object with effective laser radiation, for example an HEL effector, high-energy laser effector. The invention further relates to a laser beam apparatus with a plurality of, e.g. at least two, amplifier paths, wherein effective laser radiation produced by an effective laser source is directed and/or split at least partially into a first and at least partially into a second amplifier path via a beam directing and/or beam splitting device.

### Description of the Background Art

A particular amplifier path comprises an amplifier device for amplifying the effective laser radiation. The laser beam apparatus is designed to irradiate the target object at least temporarily simultaneously with an effective laser beam emanating from the first amplifier path and an effective laser beam emanating from the second amplifier path.

In order to irradiate the target object as effectively as possible, a coherent superposition of the effective laser beams emitted by the amplifier paths is to be achieved.

The phase relationship between the two effective laser beams required to produce coherence cannot be measured directly. Typically, indirect measurements are performed for determining the phase in which the intensity of the superposition is evaluated. When using high-power fiber lasers, the output power can vary greatly. This sometimes places very high demands on the dynamics of the evaluation. For improving the evaluation, it is also known to additionally modulate the laser power in amplitude. Such a modulation can only be transferred to high-power fiber lasers to a limited extent, since the modulation leads to nonlinear processes, which in turn leads to a limitation of the output power of the high-power fiber laser. Another problem arises when switching on high-power fiber lasers. Due to the design, phase fluctuations occur in particular when switching on, which in turn cause large fluctuations in performance. This in turn places very high demands on the dynamics of measurement, evaluation and control.

If the laser beam apparatus is used for irradiating a distant target, phase changes along the propagation path, caused, e.g., by turbulence, are added to the phase changes in the apparatus itself. This leads to a further influencing factor on the control, which can only be ascertained and corrected when the high-power fiber laser is switched on. Furthermore, when the high-power fiber laser is switched on, a luminous phenomenon may occur on the target due to the high intensity, which in turn negatively influences the evaluation of the intensity on the target.

These disadvantages are to be overcome with the present invention.

### SUMMARY OF THE INVENTION

It is therefore an object of the present invention to provide a laser beam apparatus for irradiating a target object with effective laser radiation, for example an HEL effector, high-energy laser effector. The key components of an HEL effector may include at least one laser source and a beam guide system. The beam guide system comprises, for example, functions and/or sub-assemblies such as a fine imaging system (FIS), a fine tracking system (FTS), telescope and adaptive optics. Gas lasers or solid-state lasers, for example fiber lasers, can be used as laser sources.

It is a further object of the invention to provide a laser beam apparatus with a plurality of, at least two, amplifier paths, wherein effective laser radiation produced by an effective laser source is directed and/or split at least partially into a first and at least partially into a second amplifier path via a beam directing and/or beam splitting device.

In an example, the laser beam apparatus can comprise a calibration laser source for producing calibration laser radiation, wherein the wavelength of the calibration laser radiation deviates from the wavelength of the effective laser radiation, wherein the laser beam apparatus is designed in such a way that at least a portion of the calibration laser radiation produced by the calibration laser source can be divided and/or deflected into the first and second amplifier paths at the beam directing and/or beam splitting device, and a particular amplifier path comprises a wavelength-dependent coupling-out element for coupling out at least a portion of the calibration laser light, and wherein the laser beam apparatus comprises a determinator for determining a phase of the calibration laser light of the first amplifier path and/or the calibration laser light of the second amplifier path, and wherein at least one amplifier path comprises at least one shifter for shifting the phase of laser radiation, and the at least one shifter for shifting the phase can be controlled as a function of the phase of the calibration laser light of the first amplifier path and/or the calibration laser light of the second amplifier path.

The wavelength of the calibration laser radiation differs at least slightly from the wavelength of the effective laser radiation. The wavelength of the calibration laser radiation is outside the amplifier bandwidth.

The effective laser source and the calibration laser source can be operated in such a way that the calibration laser radiation comprises a significantly lower power than the effective laser radiation. For example, the power of the calibration laser source is between 1 watt and 100 watts. The power of the effective laser source, for example, is between 100 watts and several 1000 watts. For example, the effective laser light and the calibration laser light have the same polarization. The effective laser light and the calibration laser light can also be polarized perpendicular to one another.

Via the beam directing and/or beam splitting device, both the effective laser light and the calibration laser light can be directed and/or split into each amplifier path. An example of a beam directing device is a mirror. An example of a beam splitting device is a beam splitter.

In the amplifier path, at least the effective laser radiation is amplified via the amplifier device. The amplifier device is designed in a particular amplifier path, for example, in such a way that the effective laser radiation is amplified, while calibration laser radiation is amplified at no or only at a relatively low level. This is achieved, for example, by wavelength-dependent amplification.

The wavelengths of calibration laser light and effective laser light differ. The wavelengths are advantageously close to each other. This ensures that an influence, for example phase error, on the phase of calibration laser light and effective laser light of the two wavelengths is the same or approximately the same. The wavelength of the effective laser light is, for example, 1035 nm or 1090 nm (21) and the wavelength of the calibration laser light is, for example, <1035 nm or >1095 nm (22), in any event outside the amplifier bandwidth.

The effective laser radiation and the calibration laser radiation pass through the same optical path in each amplifier path and experience the same runtime effects during operation, such as changes in length due to temperature expansion and changes in the refractive index. As a result, both receive almost the same phase error. The wavelengths of the effective laser radiation and the calibration laser radiation are thus in a phase relationship.

Via the wavelength-dependent coupling-out element, a portion of the calibration laser radiation or the entire calibration laser radiation is coupled out of a particular amplifier path. The wavelength-dependent coupling-out element is, for example, a beam splitter. For example, effective laser light is transmitted and calibration laser light is reflected and thus deflected and coupled out.

The coupled-out calibration laser light can be fed to a processor or, respectively, in each case to processors for determining a phase of the calibration laser light. If a common processor for phase determination, for example a central processing unit, is used, a ratio of the phases of the calibration laser radiation coupled out of the first amplifier path and the calibration laser radiation coupled out of the second amplifier path can be determined.

If the calibration laser radiation coupled out of the first and second amplifier paths is fed to a particular processor for phase determination, a particular phase can be ascertained, in particular relative to a reference value.

Various intensity-based methods, such as power-in-the-bucket (PiB) or an evaluation of the interference pattern, can be used for determining the phase.

Unlike effective laser radiation, the calibration laser radiation is a power-independent input variable for the intensity measurement and the phase determination based on it.

According to the invention, it is thus provided that a phase relationship of the calibration laser radiation of the first and second beam paths is ascertained. This phase relationship is used for adjusting the laser radiation of the first and second amplifier paths. According to the invention, the phase relationship of the effective laser radiation does not need to be ascertained. Since the effective laser radiation and the calibration laser radiation pass through the same optical path in each amplifier path and thus receive the same phase error, the phase relationship of the effective laser radiation can be deduced from the phase relationship of the calibration laser radiation. The advantage of using the calibration laser radiation and not the effective laser radiation for ascertaining the phase relationship is that the calibration laser radiation comprises a significantly lower power than the effective laser radiation. Due to the lower power, the calibration laser source can be operated continuously, for example, even if no irradiation of the target object with effective laser radiation has yet been carried out. Due to the use of the calibration laser radiation for determining the phase relationship, the demands on the control loop with respect to measurement dynamics and control dynamics are reduced.

Furthermore, due to the use of calibration laser radiation, the ascertaining of the phase relationship can be carried out and, in particular, the production of a phase coupling can be carried out even prior to the switching on of the effective laser source.

In the laser beam apparatus, it is further provided that at least one amplifier path comprises at least one shifter for shifting the phase, also called phase shifter, of the laser radiation. The shifter for shifting the phase can be controlled as a function of the phase of the calibration laser light of the first amplifier path and/or the calibration laser light of the second amplifier path, in particular as a function of a ratio of the two phases.

The phase shifter can be designed, for example, in one or two stages. The phase shifter can be designed, for example, as a piezo phase shifter and/or as an EOM phase shifter. A piezo phase shifter, for example, is used for large phase changes. An EOM phase shifter, for example, is used for small, rapid phase changes.

For example, a control signal for the phase shifter can be determined based on the phase or phases or the ratio of the phases, in particular via an electronic computing device, and the phase shifter can be controlled accordingly based on the control signal.

Due to the shifting of the phases of the laser radiation via the phase shifter, the phase relationship of the laser radiation of the first amplifier path and the laser radiation of the second amplifier path can be adjusted to one another in such a way that a coherent superposition of the laser radiation can be achieved. This can also be referred to as phase coupling.

It may be advantageous if a particular amplifier path comprises at least one shifter for shifting the phase of the laser radiation, and a particular processor can be controlled as a function of the phase of the calibration laser light of the first amplifier path and/or the calibration laser light of the second amplifier path.

The adjustment of the phase relationship between the laser radiation of the first amplifier path and the laser radiation of the second amplifier path for achieving coherent superposition can, in this case, be achieved by shifting the phase of the laser radiation of the first amplifier path and the laser radiation of the second amplifier path.

The coupling-out element can be arranged and designed in such a way that at least a portion of the calibration laser radiation can be coupled out of the amplifier path before it exits the amplifier path in the direction of the target object. This can also be referred to as coupling-out in the near field or near-field coupling-out or phase determination in the near field. Due to the appropriate control of the phase shifter(s) as a function of the phase of the calibration laser light of the first amplifier path and/or the calibration laser light of the second amplifier path, a coherent superposition at a nearby target can be achieved via phase determination in the near field.

The coupling-out element can be designed in such a way that calibration laser radiation reflected at the target object can be coupled out of the amplifier path. This can also be referred to as coupling-out in the far field or far-field coupling-out or phase determination in the far field. Due to the appropriate control of the phase shifter(s) as a function of the phase of the calibration laser light of the first amplifier path reflected from the target and/or the calibration laser light of the second amplifier path, a coherent superposition at a distant target can be achieved via phase determination in the far field.

At least a portion of the calibration laser radiation can be directed onto the target object by a particular amplifier path, in particular via suitable optics, for example a telescope. Due to reflections from the target object, at least a small portion of the calibration laser radiation returns to the amplifier path, in particular via the telescope.

The reflected portion of the calibration laser radiation can be fed to a phase determination via the coupling-out element, in particular a wavelength-dependent coupling-out element.

When determining the phase in the far field, in addition to the phase changes already described in the apparatus itself, in particular within a particular amplifier path, there are also phase changes along the propagation path, which are caused, e.g., by turbulence. Along the optical axis, the calibration laser radiation experiences the same or at least almost the same influence, for example phase change, refraction, in particular caused by turbulence, as the effective laser radiation. Therefore, the calibration laser radiation can also be used for determining the phase relationship in the far field.

The determination of the phase relationship according to the invention can be used for determining control parameters for achieving a coherent superposition even prior to switching on the effective laser source. In the methods and apparatuses known from the prior art, the phase relationships and thus the control parameters can only be ascertained when switching on the effective laser and then corrected. When switching on the effective laser, a luminous phenomenon may appear on the target due to the high intensity of the effective laser. This can also have a negative influence on the ascertaining of phase relationships and control parameters in the methods and apparatuses known from the prior art. According to the present invention, the phase determination in the far field can be used to compensate for the influences on the phases caused by turbulences despite the luminous phenomenon on the target produced by the effective laser.

A particular beam path can comprise at least one optical element, in particular a telescope and/or a tip/tilt mirror, for aligning laser radiation onto the target object.

It can be provided that the optical element, in particular the telescope and/or the tip/tilt mirror, in addition to or alternatively to the phase shifter, can be controlled as a function of the phase of the calibration laser light of the first amplifier path and/or the calibration laser light of the second amplifier path, in particular as a function of a ratio of the two phases, in particular for achieving a coherent superposition of effective laser radiation on the target object. In this connection, a control signal for the telescope and/or the tip/tilt mirror can be determined, in particular via an electronic computing device, and the telescope and/or the tip/tilt mirror can be controlled accordingly based on the control signal.

It can also be provided that a control signal for the telescope and/or the tip/tilt mirror can additionally be determined as a function of an evaluation of a visual capturing of the laser radiation in the target. In this case, for example, a corresponding optical sensor is provided for capturing the laser radiation in the target, for example a camera. The telescope and/or the tip/tilt mirror of a particular amplifier path can then, for example, be controlled so that the laser radiation is superimposed at one point in the target.

It can also be provided that a particular or at least one amplifier path comprises a coupling-out element for the near-field coupling-out and a coupling-out element for the far-field coupling-out.

It can also be provided that a coupling-out element is designed for both near-field and far-field coupling-out. For example, such a coupling-out element can be switched between near-field and far-field coupling-out.

The laser beam apparatus is advantageously designed to perform a calibration of the phase relationship of the wavelength 11 of the effective laser light and the wavelength 12 of the calibration laser light.

The laser beam apparatus can comprise at least one beam combiner device for combining the calibration laser radiation with the effective laser radiation, wherein the beam combiner apparatus may be arranged in such a way that the combining is carried out prior to the splitting and/or deflection of the active and/or calibration laser radiation into the at least two amplifier paths.

The laser beam apparatus can comprise a modulation device for modulating the calibration laser radiation, in particular for modulating an amplitude. The amplitude modulation can be carried out, for example, in the form of cw modulation or in pulsed form. The type of modulation can also be varied, for example, as a function of the operating mode of the laser beam apparatus. The modulation device can be arranged, for example, in front of the beam combiner device. The modulation device, for example, is controllable. The calibration laser radiation can be modulated without influencing the dynamics of the effective laser radiation.

The modulation device can, for example, be used in combination with certain receivers, in particular reception methods that can be used for phase determination and/or are a part of phase determination. Exemplary reception methods/components can be lock-in amplifiers, homodyne receivers or heterodyne receivers. In combination with the modulation of the calibration laser radiation, a signal-to-noise ratio (SNR) can be improved and thus the phase determination can be improved, for example, accelerated and/or made more precise.

Due to the modulation of the calibration laser radiation, the signal-to-noise ratio can also be improved when determining the phase relationship in the far field, for example by appropriately modulating the calibration laser radiation to reduce the influence of the luminous phenomenon on the target object produced by the effective laser radiation on the calibration laser radiation.

Further examples relate to a method for operating a laser beam apparatus according to the invention described herein. The method can comprise at least the following steps: producing calibration laser radiation and directing and/or splitting at least a portion of the produced calibration laser radiation into at least a first and at least a second amplifier path, wherein in a particular amplifier path at least a portion of the calibration laser radiation is coupled out via a wavelength-dependent coupling-out element; determining a phase of the calibration laser light of the first amplifier path and/or the calibration laser light of the second amplifier path; and controlling, as a function of the phase of the calibration laser light of the first amplifier path and/or the calibration laser light of the second amplifier path, at least one shifter for shifting the phase of laser radiation.

The method can further comprise the emission of effective laser radiation and that the at least one shifter for shifting the phase of the laser radiation is controlled in such a way that a coherent superposition of the effective laser radiation is achieved when emitting effective laser radiation.

The laser beam apparatus can be operated at least temporarily in such a way that only calibration laser radiation is emitted. This is a configuration operation, for example. In the configuration operation, no effective laser radiation, but only calibration laser radiation, is emitted. However, the shifter for shifting the phase of the laser radiation can already be controlled in such a way that, immediately when switching on the effective laser source, a coherent superposition of the effective laser beams emitted by the amplifier paths can be achieved.

The laser beam apparatus can be operated at least temporarily in such a way that calibration laser radiation and effective laser radiation are emitted simultaneously. This is, for example, normal operation, in particular as intended. For example, normal operation follows configuration operation.

The method can comprise a step of modulating the calibration laser light. This is carried out, for example, via a particularly controllable modulation device. The calibration laser radiation can advantageously be modulated without influencing the dynamics of the effective laser radiation. The amplitude modulation is carried out, for example, in the form of cw modulation or in pulsed form. The type of modulation can also be varied, for example, as a function of the operating mode. For example, the modulation can be carried out at the beginning of operation, for example during configuration operation, in pulsed form for length adjustment. For example, the modulation can subsequently carried be out during operation, for example during normal operation, in the form of cw modulation.

Modulating the calibration laser light can, for example, be used in combination with reception methods that can be used for phase determination. Exemplary reception methods are lock-in amplification, homodyne reception or heterodyne reception. In combination with the modulation of the calibration laser radiation, a signal-to-noise ratio (SNR) can be improved and thus the phase determination can be improved, for example, accelerated and/or made more precise.

The method comprises a step of calibrating the phase relationship of the wavelength 11 of the effective laser light and the wavelength 12 of the calibration laser light. Calibration, also referred to as the calibration process, comprises ascertaining and, if necessary, setting the phase relationship. This is carried out, for example, via the processor or sets of processors for phase determination, for example separately for a particular amplifier path or jointly for two or more amplifier paths.

For calibrating the phase relationship, a portion of the calibration laser radiation and a portion of the effective laser radiation are coupled out of the amplifier path via a coupling-out element.

The coupling-out element is, for example, a switchable wavelength-dependent coupling-out element, for example a beam splitter. For example, the coupling-out element can be switched between a switching state in which only calibration laser light is coupled out and between a switching state in which calibration laser light and effective laser light are coupled out.

The coupled-out calibration and effective laser light is fed to the processor for determining the phase relationship.

As a function of the ascertained phase relationship, a control signal for a particular phase shifter can be determined, in particular via an electronic computing device, and a particular phase shifter can be controlled accordingly based on the control signal. As a result, the phase relationship of the wavelength 11 of the effective laser light and the wavelength 12 can be set accordingly for a particular amplifier path. The setting of the phase relationship is advantageously carried out in such a way that the wavelengths 11 of the effective laser light of all amplifier paths are coherently superimposed.

The calibration can be performed at the beginning of the method for operating the laser beam apparatus.

Advantageously, it may be provided that the calibration is performed repeatedly during the runtime of the method for operating the laser beam apparatus. Calibration can, for example, be repeated at specified time intervals. It can also be provided to repeat the calibration after a certain number of wavelength shifts have been performed.

$$< \frac{{λ}_{1}}{10} ,$$

For example, a permissible phase error, for example can be specified. The phase difference Δ is determined by Δ=|n*λ₁−n*λ₂| as a function of 11 and 12, so that a permissible number n of direction-dependent wavelength shifts can be determined. If the permissible number n of wavelength shifts is reached or exceeded, the calibration is performed again.

It may be advantageous to reduce the power of the effective laser light during the calibration process.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a laser beam apparatus according to an example;

FIG. 2 shows a laser beam apparatus according to an example;

FIG. 3 shows a method for operating a laser beam apparatus according to FIG. 1 or 2 or 4 or 5;

FIG. 4 shows a laser beam apparatus according to an example; and

FIG. 5 shows a laser beam apparatus according to an example.

### DETAILED DESCRIPTION

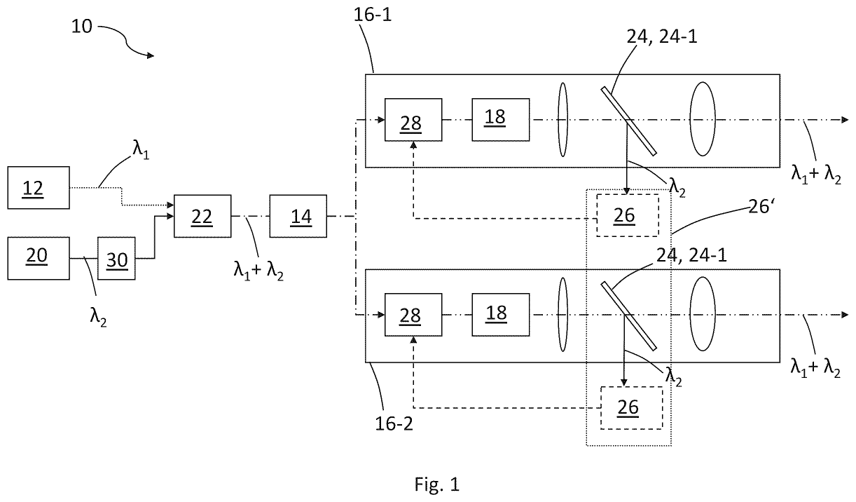

FIG. 1 shows a laser beam apparatus, which is marked in its entirety with the reference sign 10. The laser beam apparatus 10 is designed, for example, and can be operated, for example, in such a way that a target object, in particular a distant target object, for example between 10 m, in particular 50 m, to 1000 m or even more, can be irradiated with laser radiation, in particular effective laser radiation.

The laser beam apparatus is, for example, a laser weapon or a laser weapon system.

Laser weapons or laser weapon systems are used, for example, for protecting objects, whether moving or stationary. A laser weapon or laser weapon system can comprise one or more HEL (high-energy laser) effectors. Multiple HEL effectors can be simultaneously aligned to a target object or to a plurality of target objects.

These can include static target objects, such as mines, IEDs (improvised explosive devices), etc., but also dynamic targets, such as rockets, artillery shells or RAM projectiles, etc. These targets are then blown up and/or destroyed as part of countering the threat. In particular, small targets (low, slow & small=LSS targets) can be easily destroyed or blown up by such a weapon system. LSS targets also include so-called UAVs (unmanned air vehicles), such as drones, which are frequently used to transport explosives.

The key components of an HEL effector include a laser source and a beam guide system. Sub-assemblies such as the fine imaging system (FIS), fine tracking system (FTS), telescope and, if necessary, at least one adaptive optics (AO) can be accommodated in the beam guide system. Known laser sources are gas lasers, such as CO2 lasers, as well as solid-state lasers, such as diode lasers, fiber lasers, etc.

HEL effectors, like other weapon systems, can be mounted on a fixed or movable platform. In this respect, weapon stations are also referred to as platforms. These platforms can in turn be attached to stationary objects (e.g., houses, bunkers, containers, etc.) or movable objects (e.g., vehicles on land, in the air and on the sea, containers, etc.).

Aiming a high-energy laser beam at a target in a military environment represents a major technical challenge. This relates to the transmission of high laser power (high laser density) via optical systems such as mirrors and lenses. There are also high demands on track accuracy or target tracking along with focusing on a moving target, e.g., via a telescope. A further problem is compensating for atmospheric disturbances. In addition, high environmental stresses such as shock, vibration, temperature and EMC for the entire transmission system along with tracking the effect on the target in real time present a person skilled in the art with various complex tasks.

The present invention addresses the challenge of achieving a coherent superposition of effective laser beams emitted by different amplifier paths. This will be explained below with reference to the figures.

The laser beam apparatus 10 comprises an effective laser source 12 for producing effective laser radiation. The effective laser radiation is shown in FIG. 1 as a dotted line and designated Δ₁. The wavelength of the effective laser radiation is, for example, λ₁=1040 nm. The effective laser source 12 is a high-power laser.

According to the example shown, the effective laser radiation produced by the effective laser source 12 is directed and/or split at least partially into a first amplifier path 16-1 and at least partially into a second amplifier path 16-2 via a beam directing and/or beam splitting device 14. The representation in the figures is merely exemplary. For example, it may be advantageous to use more than two amplifier paths, for example between two and ten, or even twenty or more amplifier paths.

A particular amplifier path 16-1, 16-2 comprises an amplifier device 18 for amplifying the effective laser radiation. The amplifier device 18 amplifies, for example, wavelength-dependently as a function of the wavelength Δ₁.

Advantageously, the laser beam apparatus 10 is designed and can be operated in such a way that the target object is irradiated at least temporarily simultaneously with an effective laser beam emanating from the first amplifier path 16-1 and an effective laser beam emanating from the second amplifier path 16-2.

The laser beam apparatus 10 can also comprise more than two amplifier paths 16-1, 16-2.

In order to irradiate the target object as effectively as possible, a coherent superposition of the effective laser beams emitted by the amplifier paths 16-1, 16-2 is to be achieved. This is explained below.

According to the example, it is provided that the laser beam apparatus 10 comprises a calibration laser source 20 for producing calibration laser radiation. The calibration laser source 20 and the effective laser source 12 are designed in such a way that a wavelength λ₂ of the calibration laser radiation deviates from the wavelength Δ₁ of the effective laser radiation. The calibration laser radiation is shown in FIG. 1 as a solid line and is designated Δ₂. The wavelength of the calibration laser radiation λ₂ can be greater or smaller than Δ₁. Preferably, Δ₂ is outside the amplifier bandwidth of the particular laser system; for example, for a λ₁ 1040 nm amplifier, λ₂<1030 nm, or for λ₁ 1085 nm amplifier, λ₂>1090 nm).

According to the example, it is provided that the laser beam apparatus 10 comprises at least one beam combiner device 22 for combining the calibration laser radiation with the effective laser radiation. The beam combiner device 22 is arranged in such a way that the combining is carried out prior to the splitting and/or deflection of the combined active and/or calibration laser radiation into the at least two amplifier paths 16-1, 16-2.

The combined active and/or calibration laser radiation is shown in FIG. 1 as a dotted line and designated λ₁+λ₂.

Finally, via the beam directing and/or beam splitting device 14, the combined active and/or calibration laser radiation, and thus at least a portion of the calibration laser radiation produced by the calibration laser source, is directed in each case into the first and second amplifier paths 16-1, 16-2.

The calibration laser radiation experiences no or only a relatively low amplification by the amplifier device 18, since the amplification is carried out on a wavelength-dependent basis, for example as a function of the wavelength λ₁.

According to the example, it is provided that a particular amplifier path 16-1, 16-2 comprises a wavelength-dependent coupling-out element 24 for coupling out at least a portion of the calibration laser light.

According to the example shown in FIG. 1, the coupling-out element 24, also designated 24-1, is arranged and designed in such a way that at least part of the calibration laser radiation can be coupled out of the particular amplifier path 16-1, 16-2 before it exits the amplifier path in the direction of the target object.

This can also be referred to as coupling-out in the near field or near-field coupling-out, in particular for phase determination in the near field.

The laser beam apparatus 10 comprises a processor 26 for determining a phase of the calibration laser light of the first amplifier path 16-1 and/or the calibration laser light of the second amplifier path 16-2. According to the example shown, both the calibration laser radiation coupled out of the first and the second amplifier path 16-1, 16-2 is fed to a particular processor 26 for phase determination. For example, a particular phase is ascertained relative to a reference value. As a reference value, for example, a reference signal from an output on the elements labeled 14 or 30 is fed to the processor 26 for phase determination.

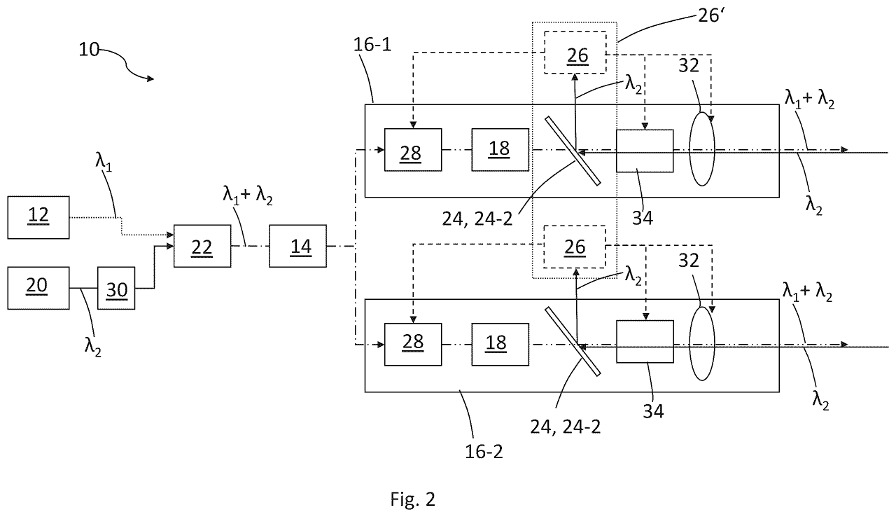

Alternatively, a common processor 26′, compare the dotted border in FIGS. 1 and 2, could also be used for phase determination and accordingly, for example, a ratio of the phases of the calibration laser radiation coupled out of the first amplifier path 16-1 and the calibration laser radiation coupled out of the second amplifier path 16-2 could be determined.

According to the example shown, a particular amplifier path 16-1, 16-2 comprises a shifter 28 for shifting the phase of laser radiation. A shifter 28 for shifting the phase of the laser radiation is, for example, a phase shifter.

The phase shifters 28 can be controlled as a function of the phase of the calibration laser light of the first amplifier path 16-1 and/or as a function of the phase of the calibration laser light of the second amplifier path 16-2. For example, the phase shifter 28 of the first amplifier path 16-1 can be controlled as a function of the phase of the calibration laser light of the first amplifier path 16-1 and the phase shifter 28 of the second amplifier path 16-2 can be controlled as a function of the phase of the calibration laser light of the second amplifier path 16-2.

For example, a control signal for a particular phase shifter can be determined based on the phase or phases or the ratio of the phases, in particular via an electronic computing device, and a particular phase shifter can be controlled accordingly based on the control signal.

Due to the modulation of the phases of the laser radiation via the phase shifters 28, the phase relationship of the laser radiation of the first amplifier path 16-1 and the laser radiation of the second amplifier path 16-2 can be adjusted to one another in such a way that a coherent superposition of the laser radiation can be achieved. This can also be referred to as phase coupling. According to the example shown in FIG. 1, a coherent superposition at a nearby target can be achieved via the phase determination in the near field.

According to the example, it is provided that the laser beam apparatus 10 comprises a modulation device 30 for modulating the calibration laser radiation, in particular for modulating an amplitude of the calibration laser radiation. The modulation device 30 is arranged, for example, in front of the beam combiner device. The modulation device 30, for example, is controllable. The calibration laser radiation can be modulated without influencing the dynamics of the effective laser radiation. In combination with the modulation of the calibration laser radiation, a signal-to-noise ratio (SNR) can be improved and thus the phase determination can be improved, for example, accelerated and/or made more precise.

FIG. 2 shows a further example of a laser beam apparatus 10.

According to the example shown, it is provided that the coupling-out element 24, also designated 24-2, is designed in such a way that calibration laser radiation reflected at the target object can be coupled out of the particular amplifier path 16-1, 16-2. This can also be referred to as coupling-out in the far field or far-field coupling-out, in particular for phase determination in the far field.

At least a portion of the calibration laser radiation is directed onto the target object by a particular amplifier path 16-1, 16-2, in particular via suitable optical means, for example a telescope 32 and/or a tip/tilt mirror 34. Due to reflections from the target object, at least a small portion of the calibration laser radiation returns to the particular amplifier path 16-1, 16-2, in particular via the telescope 32.

The reflected portion of the calibration laser radiation is fed to a phase determination 26 via the coupling-out element 24, 24-2, in particular a wavelength-dependent coupling-out element 24, 24-2.

Along the optical axis, the calibration laser radiation experiences the same or at least almost the same influence, for example phase change, refraction, as the effective laser radiation. Therefore, the calibration laser radiation can also be used for determining the phase relationship in the far field.

Due to the appropriate control of the phase shifter(s) 28 as a function of the phase of the calibration laser light of the first amplifier path 16-1 and/or the calibration laser light of the second amplifier path 16-2, a coherent superposition at a distant target can be achieved via the phase determination in the far field.

It can further be provided that the optical elements, in particular the telescope 32 and/or the tip/tilt mirror 34, in addition to or alternatively to the phase shifter 28, can be controlled as a function of the phase of the calibration laser light of the first amplifier path 16-1 and/or the calibration laser light of the second amplifier path 16-2, in particular as a function of a ratio of the two phases, in particular for achieving a coherent superposition of effective laser radiation on the target object.

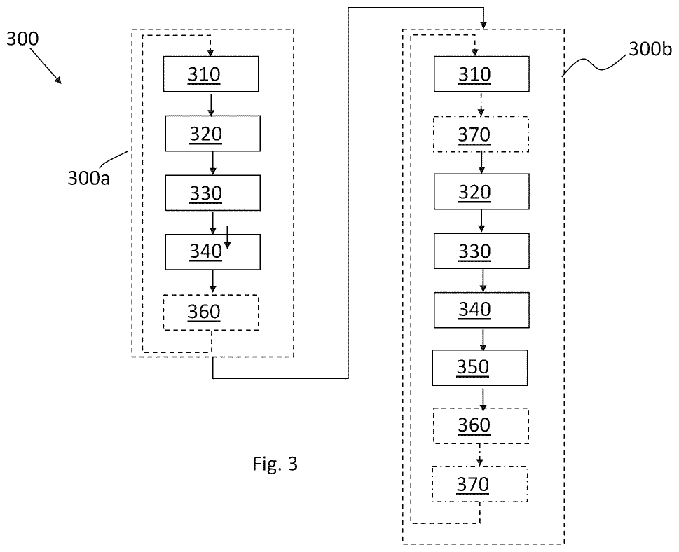

An exemplary method 300 for operating a laser beam apparatus 10 is explained with reference to FIG. 3.

The method 300 comprises at least the following steps: a step 310 for producing and emitting calibration laser radiation, in particular via a calibration laser source 20 and directing and/or splitting at least a portion of the produced calibration laser radiation into at least one first and at least one second amplifier path 16-1, 16-2, in particular via a beam directing and/or beam splitting device 14; a step 320 for coupling out at least a portion of the calibration laser radiation from a particular amplifier path 16-1, 16-2, in particular via a wavelength-dependent coupling-out element; a step 330 for determining a phase of the calibration laser light of the first amplifier path 16-1 and/or the calibration laser light of the second amplifier path 16-2; and a step 340 for controlling at least one shifter 28 for shifting the phase of laser radiation as a function of the phase of the calibration laser light of the first amplifier path 16-1 and/or the calibration laser light of the second amplifier path 16-2. Step 340 may alternatively or additionally also comprise the control of optical elements, in particular the telescope 32 and/or the tip/tilt mirror 34, in particular an alignment of these elements in addition to or alternatively to the phase shifter 28. In this connection, a control signal for the phase shifter 28 and/or for the telescope 32 and/or the tip/tilt mirror 34 is determined, in particular via an electronic computing device, and the phase shifter 28 and/or the telescope 32 and/or the tip/tilt mirror 34 are controlled accordingly based on the control signal.

The method 300 can further comprise a step 350 for emitting effective laser radiation, in particular via an effective laser source 12. In step 340, the at least one shifter 28 for shifting the phase of the laser radiation is advantageously controlled in such a way that, when emitting 350 effective laser radiation, a coherent superposition of the effective laser beams emitted by the at least two amplifier paths 16-1, 16-2 is achieved.

According to an example, it is provided that the laser beam apparatus 10 is operated at least temporarily in such a way that only calibration laser radiation is emitted. This is, for example, a configuration operation 300a. In configuration operation 300a, no effective laser radiation, but only calibration laser radiation, is emitted. The configuration operation 300a comprises, for example, steps 310, 320, 330, 340.

However, according to step 340, the shifter 28 for shifting the phase of the laser radiation can already be controlled in such a way that, with a later switching on of the effective laser source 12, a coherent superposition of the effective laser beams emitted by the at least two amplifier paths 16-1, 16-2 can be achieved immediately.

According to an example, it is provided that the laser beam apparatus 10 is operated at least temporarily in such a way that calibration laser radiation and effective laser radiation are emitted simultaneously. This is, for example, a normal operation 300b, in particular as intended. For example, normal operation 300b follows configuration operation 300a. In normal operation 300b, for example, steps 310, 320, 330, 340 and 350 are carried out.

According to an example, the method comprises a step 360 of modulating the calibration laser light. For example, step 360 can be performed both in configuration operation 300a and in normal operation 300b.

The order of steps shown is exemplary.

The steps can also be carried out in a different order and/or at least partially in parallel.

The laser apparatus 10 can be designed for carrying out a calibration process.

Accordingly, the method 300 can comprise a step of performing the calibration process. The calibration process is shown in the example as step 370.

The calibration process can be performed repeatedly at the beginning of operation and during operation of the laser apparatus.

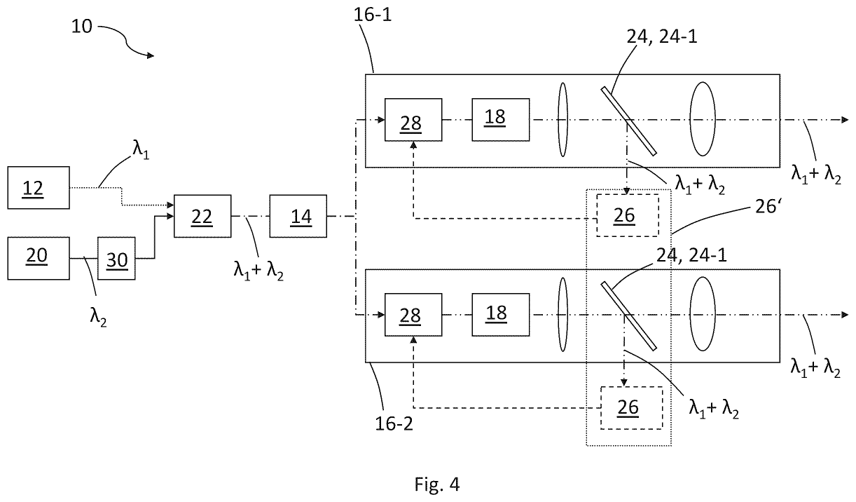

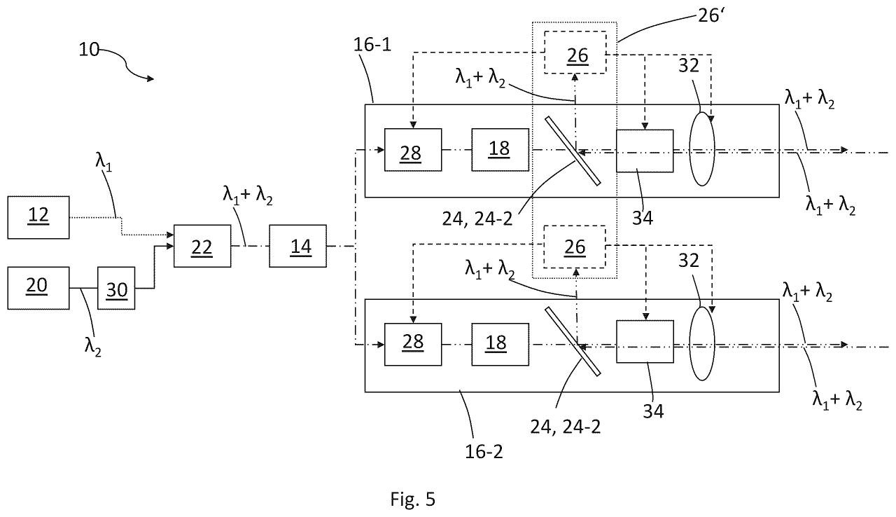

Calibration is explained with reference to FIGS. 4 and 5, for example.

The calibration process comprises calibrating the phase relationship of the wavelength 11 of the effective laser light and the wavelength 12 of the calibration laser light. Calibration comprises ascertaining and, if necessary, setting the phase relationship.

For calibrating the phase relationship, a portion of the calibration laser radiation and a portion of the effective laser radiation are coupled out of the amplifier path via a coupling-out element. The coupling-out element is, for example, the wavelength-dependent coupling-out element 24, 24-1, 24-2. The coupling-out element 24, 24-1, 24-2 is, for example, a switchable wavelength-dependent coupling-out element. For example, the coupling-out element can be switched between a switching state in which only calibration laser light is coupled out and between a switching state in which calibration laser light and effective laser light are coupled out.

For ascertaining the phase relationship, calibration laser light and effective laser light are coupled out of a particular amplifier path and fed to the processor 26, 26′ or the set of processors 26 for phase determination. The ascertaining of the phase relationship between calibration laser light and effective laser light can be carried out, for example, separately for a particular amplifier path or jointly for two or more amplifier paths.

As a function of the ascertained phase relationship, a control signal for a particular phase shifter 28 can be determined, in particular via an electronic computing device, and a particular phase shifter 28 can be controlled accordingly based on the control signal. As a result, the phase relationship of the wavelength 11 of the effective laser light and the wavelength 12 can be set accordingly for a particular amplifier path. The setting of the phase relationship is advantageously carried out in such a way that the wavelengths 11 of the effective laser light of all amplifier paths are coherently superimposed.

It can be provided that the calibration is performed at the beginning of the method for operating the laser beam apparatus.

Advantageously, it is provided that the calibration is performed repeatedly during the runtime of the method for operating the laser beam apparatus. Calibration can, for example, be repeated at specified time intervals. It can also be provided to repeat the calibration in a certain number of performed wavelength shifts.

For example, a permissible phase error, for example <λ₁/10, can be specified. The phase difference Δ is determined by Δ=|n*λ₁−n*λ₂| as a function of λ₁ and λ₂, so that a permissible number n of direction-dependent wavelength shifts can be determined. If the permissible number n of wavelength shifts is reached or exceeded, the calibration can be performed again.

It may be advantageous to reduce the power of the effective laser light during the calibration process.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A laser beam apparatus for irradiating a target object with effective laser radiation, the laser beam apparatus comprising:
a beam directing and/or beam splitting apparatus to direct and/or split at least a portion of the effective laser radiation produced by an effective laser source into at least one first and at least one second amplifier path, and the first and second amplifier paths comprising an amplifier to amplify the effective laser radiation, the laser beam apparatus being adapted to irradiate the target object at least temporarily and substantially simultaneously with an effective laser beam emanating from the first amplifier path and an effective laser beam emanating from the second amplifier path;
a calibration laser source to produce calibration laser radiation, a wavelength of the calibration laser radiation deviating from a wavelength of the effective laser radiation, the laser beam apparatus being adapted such that at least a portion of the calibration laser radiation produced by the calibration laser source is divided and/or deflected into the first and second amplifier paths at the beam directing and/or beam splitting device, and the first and second amplifier path further comprise a wavelength-dependent coupling-out element to couple out at least a portion of the calibration laser light;
at least one processor to determine a phase of the calibration laser light of the first amplifier path and/or the calibration laser light of the second amplifier path; and
at least one shifter arranged in the at least one first amplifier path to shift the phase of laser radiation, the at least one shifter for shifting the phase being controlled as a function of the phase of the calibration laser light of the first amplifier path and/or the calibration laser light of the second amplifier path.

2. The laser beam apparatus according to claim 1, wherein the at least one second amplifier path comprises at least one second shifter for shifting the phase of the laser radiation, and wherein the second shifter is controlled as a function of the phase of the calibration laser light of the first amplifier path and/or the calibration laser light of the second amplifier path.

3. The laser beam apparatus according to claim 1, wherein the at least shifter for shifting the phase of the laser radiation is or comprises a modulator, an electro-optical modulator (EOM) for modulating a phase.

4. The laser beam apparatus according to claim 1, wherein the coupling-out element is arranged and designed such that at least a portion of the calibration laser radiation is adapted to be coupled out of the amplifier path before it exits the first or second amplifier paths in the direction of the target object.

5. The laser beam apparatus according to claim 1, wherein the coupling-out element is designed such that calibration laser radiation reflected at the target object is adapted to be coupled out of the first or second amplifier path.

6. The laser beam apparatus according to claim 1, wherein the first or second amplifier path comprises at least one optical element, a telescope and/or a tip/tilt mirror for aligning laser radiation onto the target object.

7. The laser beam apparatus according to claim 1, wherein the laser beam apparatus comprises at least one beam combiner to combine the calibration laser radiation with the effective laser radiation, wherein the beam combiner is arranged such that the combining is carried out prior to the splitting and/or deflection of the active and/or calibration laser radiation into the at least first and/or second amplifier paths.

8. The laser beam apparatus according to claim 1, wherein the laser beam apparatus comprises a modulation device to modulate the calibration laser light or to modulate an amplitude.

9. A method for operating the laser beam apparatus according to claim 1, the method comprising:
producing calibration laser radiation and directing and/or splitting at least a portion of the produced calibration laser radiation into at least a first and at least a second amplifier path, wherein in the first or second amplifier path at least a portion of the calibration laser radiation is coupled out via a wavelength-dependent coupling-out element;
determining a phase of the calibration laser light of the first amplifier path and/or the calibration laser light of the second amplifier path; and
controlling, as a function of the phase of the calibration laser light of the first amplifier path and/or the calibration laser light of the second amplifier path, at least one modulator to modulate laser radiation.

10. The method according to claim 9, wherein an emission of effective laser radiation and the at least one shifter to shift the phase of the laser radiation is controlled such that a coherent superposition of the effective laser radiation is achieved when emitting effective laser radiation.

11. The method according to claim 9, wherein the laser beam apparatus is operated at least temporarily such that only calibration laser radiation is emitted.

12. The method according to claim 9, wherein the laser beam apparatus is operated at least temporarily such that calibration laser radiation and effective laser radiation are emitted substantially simultaneously.

13. The method according to claim 9, wherein the method comprises a step of modulating the calibration laser light.

14. The method according to claim 13, wherein modulating comprises a modulation of the amplitude, and the modulation is carried out as cw modulation and/or in pulsed form.
